(19) United States
(12) Patent Application Publication
(10) Pub. No.: US 2002/0074703 A1
(43) Pub. Date: Jun. 20, 2002

(54) Device for fixing workpieces

(75) Inventors: Kurt Schmalz, Dornstetten (DE); Thomas Eisele, Fluorn-Winzeln (DE); Ralf Stockburger, Glatten (DE)

Correspondence Address: RADER, FISHMAN & GRAUER PLLC, 39533 WOODWARD AVENUE, SUITE 140, BLOOMFIELD HILLS, MI, 48304-0610, US

(73) Assignee: J. Schmalz GmbH

(21) Appl. No.: 09/789,858

(22) Filed: Feb. 21, 2001

(30) Foreign Application Priority Data
Feb. 25, 2000 (DE) 100 09 026.5

(51) Int. Cl. B25B 11/00

(52) U.S. Cl. 269/21

(57) ABSTRACT

The invention pertains to a device for fixing workpieces and contains at least one clamping beam and a suction block that lies on the clamping beam. The suction block is mounted on a sled that can be displaced in the longitudinal direction of the clamping beam. In addition, the suction block can be lifted off the surface of the clamping beam.

### TECHNICAL FIELD

The invention generally relates to material handlery systems and more particularly relates to a device for fixing workpieces, in particular, plate-shaped workpieces.

### BACKGROUND OF THE INVENTION

A device for fixing workpieces is known from EP 0 687 521 A1. In this case, the workpiece lies on and is held by a series of suction blocks. These suction blocks are arranged on sleds that can be displaced in a first direction. The suction blocks are also provided with a drive such that they can be displaced on the sleds. The disadvantage of this device can be seen in the fact that when displacing the suction block on its sled, the seal of the suction block which rests on the upper side of the sled is worn out. Consequently, it is possible that the suction blocks no longer rest on the sleds in a sealed fashion after a certain operating time and thus are no longer optimally fixed. In addition, it is not possible to subsequently mill the reference surface that, for example, is formed by the upper edge of the clamping beam in order to achieve the required dimensional accuracy after the start-up of the machine.

The invention is based on the objective of additionally developing a device of the initially described type in such a way that the operating time is extended and a subsequent milling option is provided.

According to the invention, this objective is attained with a device of the initially described type due to the fact that a device for lifting the suction block off the clamping beam is provided, and the fact that this device is functionally independent of the drive.

In the device according to the invention, the suction block is lifted off the clamping beam before its displacement to such a degree that the seal no longer contacts the clamping beam, i.e., the seal is no longer affected by the displacement. In addition, processing residues which may lie on the surface of the clamping beam can no longer damage the seal during the displacement of the suction block. Since the device for raising the suction block is functionally independent of the drive, the suction block can be raised before it is displaced.

Another lifting device utilizes the force of magnets. In this case, one magnet is, for example, provided in the clamping beam and another magnet is provided in the suction block such that forces that repulse one another can be generated. According to another variation, the lifting device generates an air cushion for the suction block, with said air cushion raising the suction block.

The drive may either be used for displacing the suction block or for detecting its position. In this variation, the suction block is, for example, manually displaced after it has been raised.

According to one additional development, the drive is arranged on a base plate, and the base plate can be displaced by means of the lifting device. Due to this measure, the device displaces, in particular, raises the entire drive including the suction block. This provides the advantage that the means between the drive and the suction block which transmit the driving force are not affected by the lifting of the suction block.

According to one additional development, the base plate is provided with longitudinal guides, and at least one carrier for the suction block which can be displaced in the longitudinal direction is arranged on the longitudinal guides. This carrier can be displaced on the longitudinal guides and carries along the suction block. The suction block can be coupled to the carrier such that the carrier can always be equipped with the suitable suction block. This may be carried out manually or automatically. Corresponding couplings or catch elements are provided on the carrier for fixing the suction block.

It would also be conceivable to utilize the principle of an air cushion. In this case, the suction block floats on an air cushion such that the seal is protected when the suction block is displaced.

According to the invention, the device is able to lift the base plate with the carrier and the suction block. This means that the entire unit consisting of the suction block, the drive and the displacement elements is displaced in such a way that the arrangement of the aforementioned components relative to one another is preserved while the position relative to the clamping beam is changed, namely in such a way that the suction block is lifted off the upper side of the clamping beam.

According to one additional development, the suction block can be pressed onto the upper side of the clamping beam by means of the carrier and the device. This provides the significant advantage that vacuum devices for attracting the suction block to the clamping beam by suction can be eliminated. Consequently, only one vacuum device for attracting the workpiece to the suction block by suction is required. The suction block may also be held in its position by the mechanical connection to the drive.

According to one preferred variation, the carrier is realized in an essentially U-shaped fashion and encompasses the clamping beam from the bottom. The suction block is removably mounted on the free ends. The suction block is connected to the drive, in particular, a toothed belt that is driven by the drives, by means of the carrier, namely with corresponding clamping means. In another variation, the carrier extends through the clamping beam with the aid of a groove. In this case, the suction surface of the clamping beam is interrupted.

In the variations of the invention, linear motors, in particular, flat linear motors can also be considered as drives. It would also be conceivable to utilize friction wheel drives that may be provided on the suction block or on the console. In addition, drives that are based on the principle of magnetic forces can be utilized. Drives that are based on the nozzle principle, in which the suction block is driven by means of a fluid that emerges from a nozzle, would also be conceivable. A drive by means of a cable can also be used. It should also be mentioned that conveyor belts may be considered for transporting and guiding the suction blocks. The suction blocks may also be transported and guided in accordance with the induction principle.

When not in use, the suction apparatuses can, according to the invention, be laterally pivoted away from the clamping beam such that they do not impair ensuing processing steps.

It is preferred that each clamping beam contains several suction blocks, with each suction block being provided with a separate drive. Due to this measure, it is easily possible to fix workpieces of different sizes and shapes on the clamping beam or on several clamping beams by displacing the individual suction blocks into the desired positions independently of one another. Since each suction block is provided with a separate drive, it is possible to displace the suction blocks independently of one another and with different speeds.

In order to make it possible to position the suction blocks at any location of the clamping beam, vacuum channels are provided in each clamping beam, and several vacuum valves are provided on the upper side of each clamping beam. These vacuum valves are spaced apart from one another in the longitudinal direction of the clamping beam, namely by a distance that is smaller than the region covered by the effective suction surface of the suction block viewed in the longitudinal direction of the clamping beam. This means that at least one vacuum valve is always covered by the suction block, namely independently of the fact at which position the suction block is situated on the clamping beam. The seal preferably has a width that is greater than the diameter of the vacuum valve.

### BRIEF DESCRIPTION OF THE DRAWINGS

FIG. 1, a (partially sectioned) side view of a clamping beam with displaceable suction blocks;

FIG. 2, section II-II according to FIG. 1 through the clamping beam;

FIG. 3, an enlarged representation of the detail III according to FIG. 2 of the clamping beam;

FIG. 4, an enlarged representation of the detail IV according to FIG. 1 of the clamping beam, and

FIG. 5, a cross section through the clamping beam with attached suction block.

### DETAILED DESCRIPTION OF THE PREFERRED EMBODIMENTS

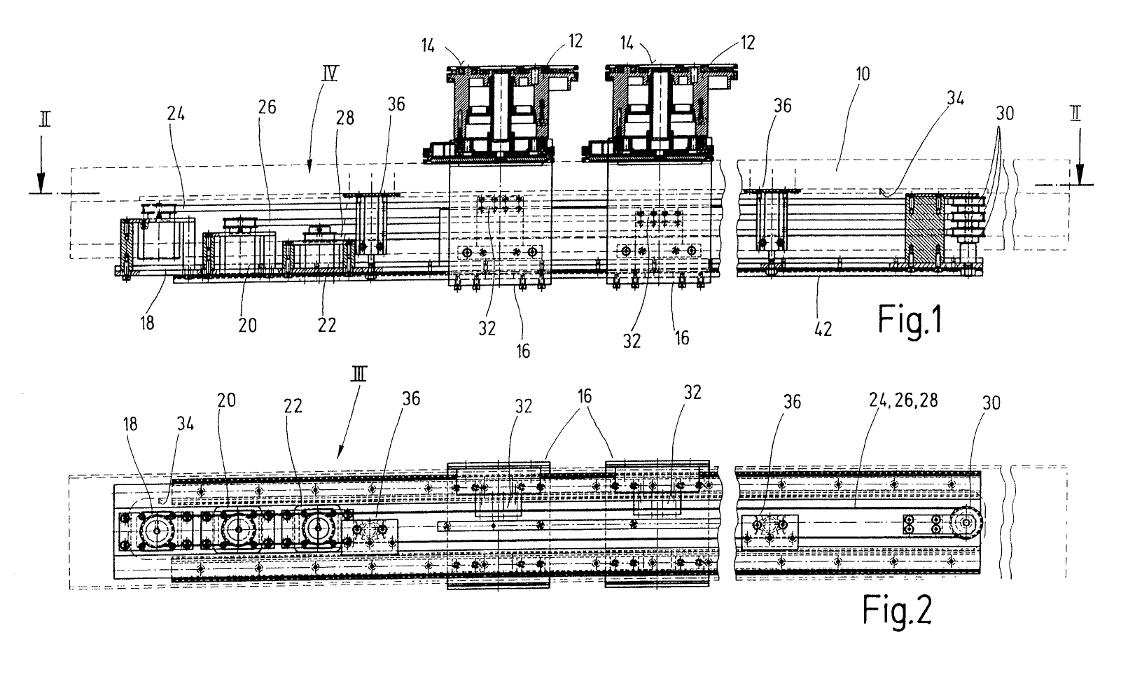

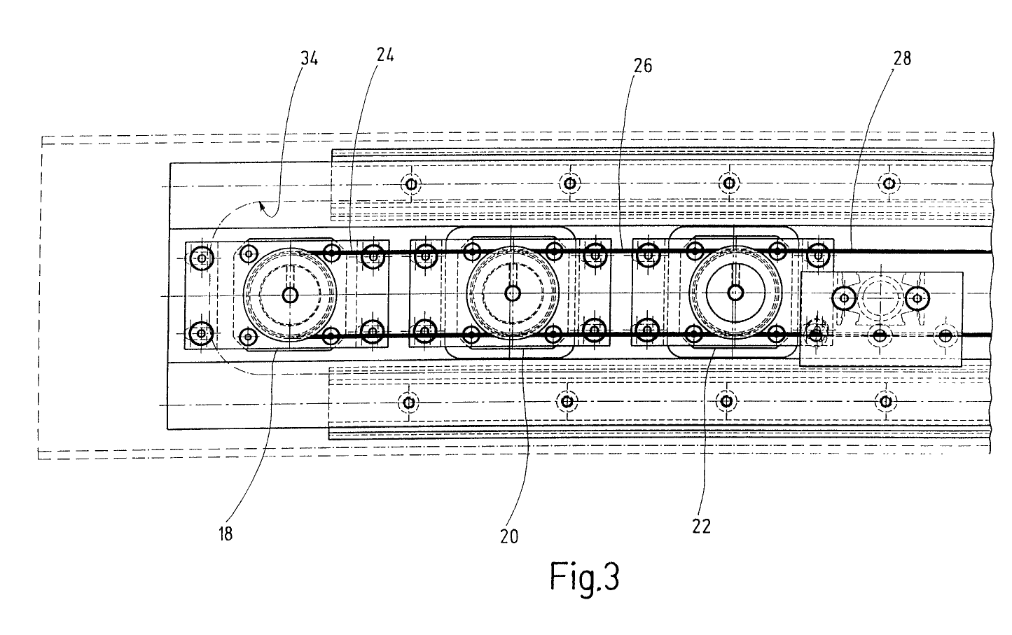

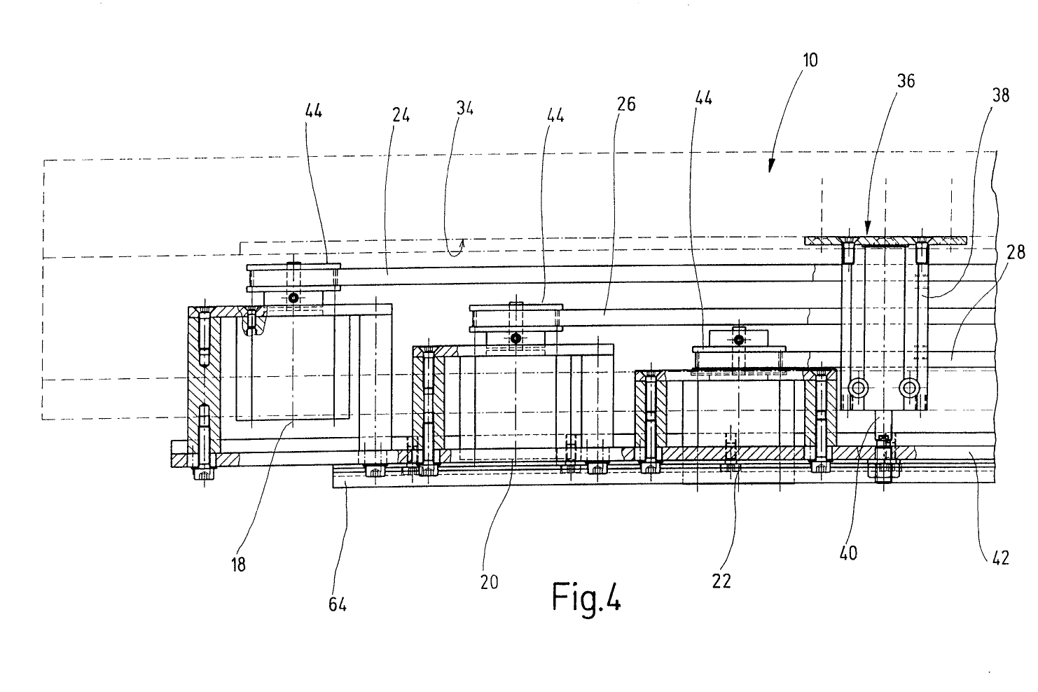

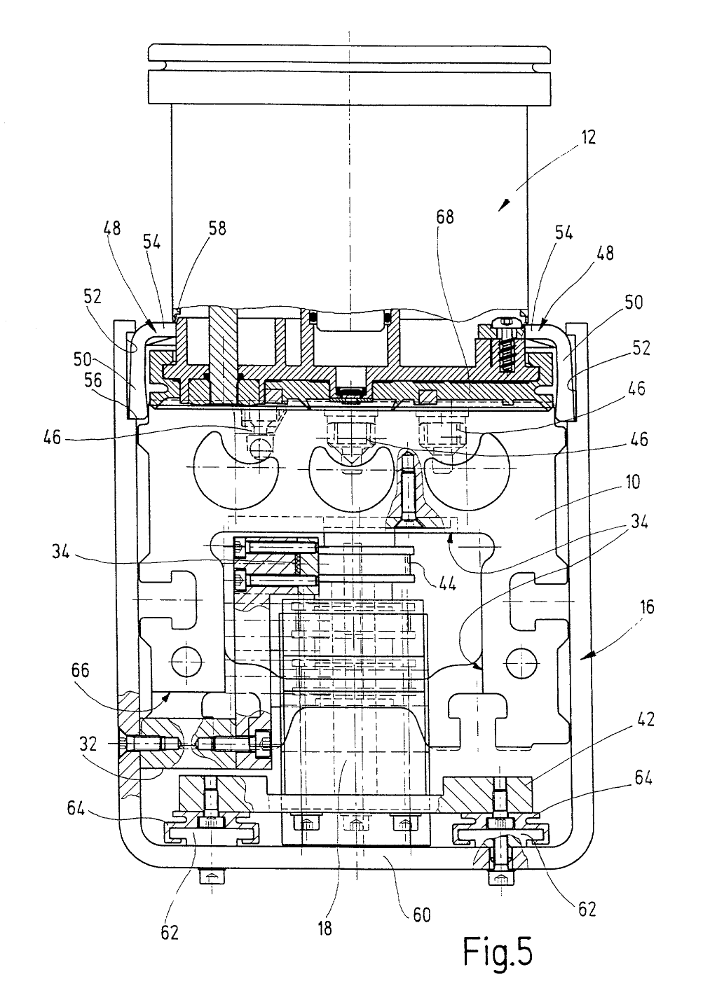

FIG. 1 shows a side view of a clamping beam 10 that consists, as also shown in FIG. 5, of a section of an extruded profile with channels that extend in the longitudinal direction, e.g., for conveying a vacuum or compressed air. Two suction blocks 12 are movably arranged on this clamping beam 10, with the suction blocks 12 containing a clamping surface for accommodating and fixing a (not-shown) workpiece on their upper side 14. One additional clamping surface that serves for fixing the suction blocks 12 on the upper side of the clamping beam 10 is provided on the underside of the suction blocks 12.

Each suction block 12 is removably mounted on a carrier 16 such that the carrier 16 can be equipped with the respectively suitable suction block 12. FIG. 5 indicates that the carrier 16 is realized in a U-shaped fashion and encompasses the clamping beam 10 from the bottom.

Three drives 18, 20 and 22 are provided in the clamping beam 10, with said drives being controlled, for example, by means of a BUS-system and respectively driven via toothed belts 24, 26 and 28. These toothed belts 24, 26 and 28 lie in different planes and serve for driving one respective carrier 16. The toothed belts 24-28 are looped around deflection rollers 30 on the side that is situated distant from the drives 18-22. The toothed belts 24-28 are connected to the carriers 16 by means of a clamping connection 32.

FIG. 2 shows that the clamping beam 10 is provided with a recess 34 such that the drives 18-22, the toothed belts 24-28, the deflection rollers 30 and devices 36 for raising the suction blocks can be accommodated. The devices 36 are realized in the form of piston/cylinder units, with the cylinder 38 being rigidly connected to the clamping beam 10 and the piston 40 being connected to a base plate 42. The three drives 18-22 are mounted on this base plate 42 in such a way that their driving wheels 44 that serve for driving the toothed belts 24-28 lie in different planes. FIGS. 1 and 2 indicate that at least two such devices 36 are provided in order to make it possible to uniformly raise and lower the base plate 42 over its entire length by moving the pistons 40 into and out of the cylinders 38.

FIG. 5 shows a cross section through the clamping beam 10 with an attached suction block 12. Several vacuum and blow-off valves 46 are situated on the upper side of the clamping beam 10, with said valves serving for attracting the suction block 12 to the upper side of the clamping beam 10 by suction and for attracting a (not shown) workpiece to the upper side 14 of the suction block 12 by suction and for cleaning the console, e.g., for removing wood chips. For this purpose, a blow-off channel for compressed air is provided adjacent to the vacuum channel(s). As mentioned previously, one can clearly ascertain that the carrier 16 is realized in a U-shaped fashion and encompasses the clamping beam 10 from the bottom. The free ends of the carrier 16 are designed in such a way that angled sections 48 for fixing the suction blocks 12 to the carrier 16 can be mounted thereon. The angled sections 48 essentially have the shape of an L, with one limb 50 engaging into a recess 52 on the inner side of the free ends of the carrier 16 and the other limb 54 being mounted on the suction block 12, e.g., by means of a screw. The free end of the limb 50 is supported on a shoulder 56 such that the angled sections 48 are moved upward with the carrier 16 when the carrier is raised. The angled sections 48 also serve as guide elements for the suction block 12 on the clamping beam 10. On its free ends, the carrier 16 contains driving hooks that engage behind the angled sections 48. According to a not-shown variation, the angled sections 48 are provided with extended limbs 50 which are directly connected to the base plate 42 in this case.

Two rails 62 that are guided in longitudinal guides 64 are mounted to the base 60 of the carrier 16. These longitudinal guides 64 are screwed to the underside of the base plate 42 which, in turn, is connected to the piston 40 of the device 36. One can also ascertain that the carrier 16, in particular, its left limb, is connected to the toothed belt 24 by means of the clamping connection 32. This clamping connection 32 extends out of the clamping beam 10 through a recess 66.

When the device 36 is actuated by moving the piston 40 into the cylinder 38, the base plate 42 is raised by the piston 40. The carrier 16 is also raised together with the base plate 42 by means of the longitudinal guides 64 and the rails 62, with the suction block 12 being raised to such a degree together with the carrier due to the angled sections 48 that its sealing elements 68 are lifted off the upper side of the clamping beam 10. The drives 18-22 are then actuated such that the toothed belts 24-28 are set in motion. The carriers 16 are fixed to the toothed belts 24-28 by means of the clamping connections 32, with said carriers being displaced in the longitudinal direction of the clamping beam 10. The carriers 16 are precisely guided by the rails 62 and the longitudinal guides 64. Once the suction block 12 has assumed the intended position, the drives 18-22 are stopped and the device 36 is deactivated such that the piston 40 is moved out of the cylinder 38. The suction block 12 is placed onto the upper side of the clamping beam 10 in this fashion. The suction block 12 may, if so required, be pressed onto the upper side of the clamping beam 10 by the device 36.

The device according to the invention makes it possible to displace the suction blocks 12 without wearing out their sealing elements 68 or without damaging said sealing elements by processing residues that lie on the upper side of the clamping beam 10. Another advantage can be seen in the fact that arbitrary suction blocks 12 can be mounted on the carriers 16 by means of suitable angled sections or clamping means 48. If so required, the upper side of the clamping beam 10 can also be processed, e.g., for removing uneven surface sections. Neither the drives 18-22 nor the devices 36 are influenced by the processing.

Stepper motors that may contain a measuring system and operate in connection with toothed belts 24-28, toothed racks or spindles may be considered as the drives 18-22. According to one variation, servo motors with a separate displacement measuring system are used. It would also be conceivable to utilize pneumatic cylinders that operate without piston rods. Alternatively, vacuum cylinders may also be used. In addition, linear motors may be considered as drives.

1. Device for fixing workpieces, in particular, plate-shaped workpieces, with at least one clamping beam (10), at least one suction block (12) that lies on the clamping beam (10) and a drive (18, 20, 22) for transporting the suction block (12) in the longitudinal direction of the clamping beam (10) or for driving a position detector for detecting the position of the suction block (12), with the suction block (12) and the drive (18, 20, 22) forming one functional unit, characterized by the fact that a device (36) is provided for raising the suction block (12), with said device (36) being independent of the drive (18, 20, 22).

2. Device according to claim 1, characterized by the fact that the drive (18, 20, 22) is arranged on a base plate (42), and by the fact that the base plate (42) can be raised by means of the device (36).

3. Device according to claim 2, characterized the fact that the base plate (42) is provided with longitudinal guides (64), and by the fact that at least one carrier (16) for the suction block (12) which can be displaced in the longitudinal direction is arranged on the longitudinal guides (64).

4. Device according to claim 3, characterized by the fact that the suction block (12) can be coupled to the carrier (16).

5. Device according to claim 3, characterized by the fact that the device (36) is able to raise the base plate (42) together with the carrier (16) and the suction block (12).

6. Device according to claim 3, characterized by the fact that the suction block (12) can be pressed onto the upper side of the clamping beam (10) by means of the carrier (16) and the device (36).

7. Device according to one of claims 3-6, characterized by the fact that the carrier (16) is essentially realized in a U-shaped fashion and encompasses the clamping beam (10), in particular, from the bottom.

8. Device according to one of the previous claims, characterized by the fact that each clamping beam (10) contains several suction blocks (12), and by the fact that each suction block (12) is provided with a separate drive (18, 20, 22).

9. Device according to one of the previous claims, characterized by the fact that each clamping beam (10) is provided with several vacuum valves (46) on its upper side, with said vacuum valves being spaced apart from one another in the longitudinal direction of the clamping beam (10) by such a distance that the effective suction surface of the suction block (12) viewed in the longitudinal direction of the clamping beam (10) always covers one vacuum valve (46).
